(19) United States
(12) Patent Application Publication
(10) Pub. No.: US 2024/0410033 A1
(43) Pub. Date: Dec. 12, 2024

(54) METHOD FOR RECOVERING VALUABLE METALS FROM WASTE BATTERIES USING SYNERGISTIC EFFECTS

(71) Applicant: POSTECH RESEARCH AND BUSINESS DEVELOPMENT FOUNDATION, Pohang-si (KR)

(72) Inventors: Yong Tae KIM, Pohang-si (KR); Young Jin LIM, Pohang-si (KR)

(21) Appl. No.: 18/665,807

(22) Filed: May 16, 2024

(30) Foreign Application Priority Data
Jun. 7, 2023 (KR) 10-2023-0072611

(51) Int. Cl. C22B 3/00; C22B 7/00; C22B 15/00; H01M 10/54

(52) U.S. Cl. CPC C22B 23/0484; C22B 7/006; C22B 15/0063; C22B 23/0415; H01M 10/54

(57) ABSTRACT

A method for recovering valuable metals from waste batteries according to one embodiment of the present invention comprises: an impurity removal process for removing impurities comprising Cu from a waste battery raw material and discharging an aqueous phase comprising Ni and Co; and a Co extraction process to extract Co from the aqueous phase comprising Ni and Co and discharge an aqueous phase comprising Ni, wherein the impurity removal process may be carried out by mixing a dialkylphosphoric acid-based solvent extractant with another solvent extractant having a synergistic effect to increase the separation factor of Co and Cu.

### TECHNICAL FIELD

The present invention relates to a method for recovering valuable metals from waste batteries and, more specifically, to a wet extraction method that utilizes a synergistic effect to remove Cu from waste lithium batteries, which has traditionally been poorly separated from waste lithium batteries, thereby reducing the cost of the cleaning process.

### BACKGROUND

Sales and distribution of electric vehicles (EVs) are predicted to significantly increase in the future, leading to a corresponding rise in the quantity of waste batteries. Specifically, global EV sales are expected to double to 6.6 million units in 2021 and continue to grow. The amount of end-of-life (EOL) waste batteries is projected to increase more than 80-fold, from 42 GWh in 2025 to 345 GWh in 2030 and 3,455 GWh by 2040. Typically, a battery is deemed EOL when it retains 80% or less of its original capacity, at which point EVs experience reduced range, slower charging, and the risk of rapid discharge. Consequently, the recycling of EOL waste batteries is gaining importance.

Waste battery recycling technology involves extracting valuable metals from the cathode active material of spent batteries. Following a pretreatment process, these metals are obtained in powder form via solvent extraction.

This recycling process is executed through two methods: dry and wet smelting. Dry smelting involves the use of high temperatures to extract metals as slag, a process that is straightforward but energy-intensive and emits harmful gases. Wet smelting, on the other hand, uses organic solvents to extract metals from electrode materials, enabling operations in low-capacity facilities with high purity output. However, this method is lengthy, complex, and the management of solutions incurs high costs.

Given that material costs account for 71% of the cell manufacturing cost for NCM811, the battery type most commonly used in today's EVs, extracting valuable metals from waste batteries holds significant value. Specifically, recycling NCM111 batteries generates a value of $42 per kilowatt-hour (compared to $15 per kilowatt-hour for LFP batteries), not only offering high profitability but also providing a higher concentration of raw materials than the highest-grade lithium mined from ore.
Prior art: Korean Patent No. 10-2396644

### SUMMARY

The present invention aims to provide a method for recovering valuable metals from waste batteries, in particular, a wet extraction method for separating Cu and recovering Co, which increases the efficiency of the extraction process by reducing the number of steps in the cleaning process.

In particular, the present invention aims to provide a wet extraction method that provides effective separation between metals in the extraction process and reduces the number of steps in the impurity separation process by using a synergistic effect.

However, the various challenges that the present invention seeks to address are not limited thereto, and are set forth in the detailed description of the invention.

To address the above-mentioned challenges, a method for recovering valuable metals from waste batteries according to one embodiment of the present invention comprises: an impurity removal process comprising separating an organic phase comprising Cu from a mixture of an aqueous phase and an organic phase comprising waste battery waste liquid and a solvent extractant to remove impurities and discharge an aqueous phase comprising Ni and Co; and a Co extraction process for extracting Co from the aqueous phase comprising Ni and Co to discharge an aqueous phase comprising Ni, wherein the impurity removal process may be performed by mixing dialkylphosphoric acid-based solvent extractant as a solvent extractant with another solvent extractant having a synergistic effect to increase the separation factor of Co and Cu.

In this case, the method of recovering a valuable metal from a waste battery may further comprise a Ni extraction process to extract Ni from an aqueous phase comprising Ni.

In this case, the synergistic effect is the effect that the enthalpy of the reactant is lower than the enthalpy of the product when mixing the other solvent extractants in a reaction in which dimers and impurities of the dialkylphosphoric acid-based solvent extractant are combined to form a complex.

Furthermore, other solvent extractants that exhibit the above synergistic effects may include dialkylphosphonic acid-based solvent extractant and dialkylphosphinic acid-based solvent extractant.

Furthermore, the dialkylphosphoric acid-based solvent extractant and the another solvent extractant exhibiting the above synergistic effect may be mixed in a ratio of 1:1 to 3:1.

Additionally, the dialkylphosphoric acid-based solvent extractant and the another solvent extractant exhibiting the above synergistic effect may be mixed in a 2:1 ratio.

Furthermore, in the above impurity removal process, the reaction in which the dimer of the dialkylphosphoric acid-based solvent extractant and the impurity are combined to form a complex may occur at pH 2.0 to pH 3.0.

Further, the aqueous phase is an aqueous solution of sulfuric acid or hydrochloric acid, and the organic phase is an organic solution containing hydrodesulfurized kerosene, a solution of dialkylphosphoric acid-based solvent extractant with dialkylphosphonic or dialkylphosphinic acid-based solvent extractants, and the aqueous phase and the organic phase are mixed in a first chamber under high-speed rotation through a settler, and then transferred to a second chamber to be separated by density.

Therefore, according to an embodiment of the present invention, a method for recovering valuable metals from waste battery liquid can be provided, which may improve efficiency in the extraction and cleaning processes by reducing the number of steps involved, particularly offering a method for separating Cu and recovering Co.

In particular, according to an embodiment of the present invention, a wet extraction method can be provided, which ensures effective separation between metals in the extraction process and utilizes a synergistic effect to reduce the number of steps in the impurity separation process. More specifically, by removing Fe, Al, Cu, Ca, and Zn from the battery in a first impurity removal process, this embodiment can significantly reduce the cost of the cleaning process, especially by synergistically removing Cu, which has traditionally been difficult to separate. Furthermore, although research on waste battery recycling has recently begun to emerge, there has been a scarcity of studies on identifying suitable solvent extraction conditions for waste batteries. An embodiment of this invention has efficiently removed Mn and Cu, apart from Ni, Co, and Li, which are essential for extraction under waste battery conditions.

Conventionally, solvent extraction processes have been operated on a large plant scale, making it challenging to control pH, temperature, and the volume of solution. Consequently, there has been limited research on mixed solvents where the volume and pH are difficult to control. This invention derives solvent combinations and calculation of the number of steps for more effective extraction processes without the need for plant-scale experiments, utilizing E-pH relationship graphs and Density Functional Theory (DFT) calculations at the lab scale. The application of this invention is anticipated to aid in process design based on DFT calculations and lab-scale experiments and is expected to reduce the operational costs of the impurity separation process based on synergistic effects.

However, the effects of the present invention are not limited to the examples provided above; many more effects are envisioned herein.

### BRIEF DESCRIPTION OF THE FIGURES

This invention is illustrated in the accompanying drawings, throughout which like reference letters indicate corresponding parts in the various figures. The embodiments herein will be better understood from the following description with reference to the drawings, in which:

FIG. 1 is a diagram illustrating a method for wet extraction of batteries according to one embodiment of the present invention.

FIG. 2 is a diagram illustrating an impurity removal process according to one embodiment of the present invention.

FIGS. 3A and 3B are drawings illustrating an apparatus for performing an impurity removal process according to one embodiment of the present invention.

FIG. 4 is a schematic diagram for illustrating the aqueous phase and organic phase in an impurity removal process according to one embodiment of the present invention.

FIG. 5A is a diagram illustrating a dimer of D2EHPA, a dialkylphosphoric acid-based solvent extractant according to one embodiment of the present invention.

FIG. 5B is a diagram illustrating a PC88A dimer, a dialkylphosphonic acid-based solvent extractant, according to one embodiment of the present invention.

FIG. 5C is a diagram illustrating CYANEX272, a solvent extractant dialkylphosphinic acid, according to one embodiment of the present invention.

FIG. 5D is a diagram illustrating the dialkyl phosphate complex upon extraction of Cu according to one embodiment of the present invention.

FIG. 6 is a diagram illustrating the structure of a dialkylphosphoric acid-based solvent extractant according to one embodiment of the present invention.

FIG. 7 is a diagram illustrating the structure of a dialkylphosphonic acid-based solvent extractant according to one embodiment of the present invention.

FIG. 8 is a diagram illustrating the structure of a dialkylphosphinic acid-based solvent extractant according to one embodiment of the present invention.

FIGS. 9A, 9B, and 9C are graphs showing extraction curves for dialkyl phosphoric acid, dialkylphosphonic acid, and dialkylphosphinic acid, respectively.

FIGS. 10A and 10B are graphs showing the extraction curves of mixing a dialkylphoric acid-based solvent extractant with CYANEX272 and a dialkylphosphoric acid-based solvent extractant with PC88A, respectively, according to one embodiment of the present invention.

FIG. 11 is a diagram illustrating the retention of Cu and Co in the organic and aqueous phases when using a mixed solvent extractant according to one embodiment of the present invention and a prior art unmixed solvent extractant.

FIG. 12 is a graph comparing the amount of extraction using mixed solvent extractants according to one embodiment of the present invention with the prior art unmixed solvent extractant.

FIG. 13 is a curve representing a DFT computation according to one embodiment of the present invention.

### DETAILED DESCRIPTION OF INVENTION

Embodiments of the present invention will now be described in detail with reference to the accompanying drawings. However, the invention is not limited to the embodiments disclosed herein, but may be embodied in many different forms, and the following embodiments are provided to make the disclosure of the invention complete and to give those of ordinary skill in the art a complete idea of the scope of the invention. In addition, components may be exaggerated or reduced in size in the drawings for ease of illustration.

However, the following embodiments are provided so that the invention will be fully understood by those of ordinary skill in the art and may be modified in many other ways, and the scope of the invention is not limited to the embodiments described below.

On the other hand, throughout the specification, when a part is the to “comprise” a component, it means that it may further include other components, not that it excludes other components, unless specifically stated to the contrary.

The foregoing objects, features and advantages will become more apparent from the following detailed description with reference to the accompanying drawings, which will enable one having ordinary skill in the technical field to which the invention belongs to practice the technical ideas of the invention with ease.

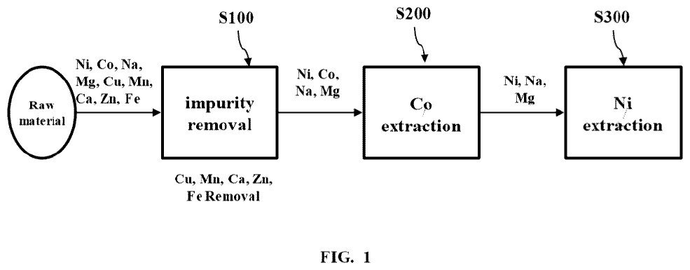

Hereinafter, with reference to FIGS. 1 to 3, the overall extraction process according to one embodiment of the present invention will be described.

Referring to FIG. 1, the overall wet extraction method may include an impurity removal step S100, a Co extraction step S200, and a Ni extraction step S300.

First, the impurity removal step S100 performs an impurity removal process by mixing a battery waste liquid containing Ni, Co, Mg, Cu, Mn, Ca, Zn, and Fe with a mixed solvent extractant including a dialkylphosphoric acid-based solvent extractant to remove Cu, Mn, Ca, Zn, and Fe.

The solution from which the impurities were removed in the impurity removal step S100 is again mixed with a dialkylphosphonic acid-based solvent extractant, for example, PC88A (Mono-2-ethylhexyl (2-Ethylhexyl)phosphonate) to extract Co. (S200) Finally, the mixed solution of Ni and Mg is mixed with solvent extractant VA10 to extract Ni. (S300)

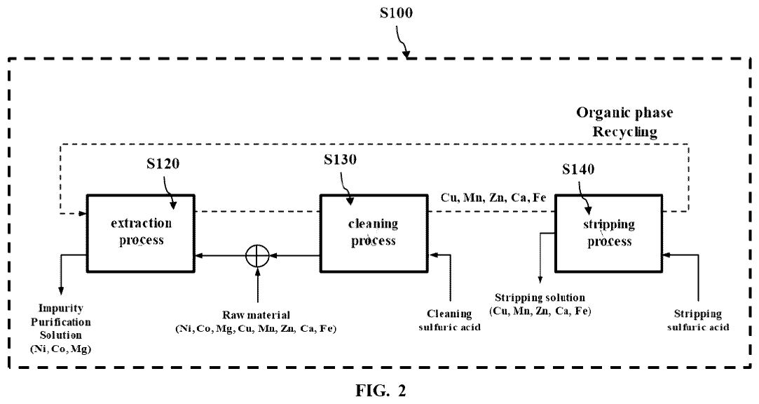

Referring to FIG. 2, the impurity removal process S100 includes an extraction process S120, a cleaning process S130, and a stripping process S140. In this case, first, when the raw material is fed in, the extraction part removes Ni, Co, and Mg from the organic phase and extracts Ni, Co, and Mg in the aqueous phase.

Specifically, the cleaning process S130 precipitates Mg, Ca, Al, Fe, etc. by adding sulfuric acid and hydrogen peroxide reducing agent, the extraction process $120 is a process of discharging an aqueous solution of Ni purified from impurities including elements other than Ni, Co, and Mg. In the extraction process. The elements other than Ni, Co, and Mg can separated with D2EHPA (Bis(2-ethylhexyl)phosphoric acid). And the stripping process S140 is a process of removing impurities.

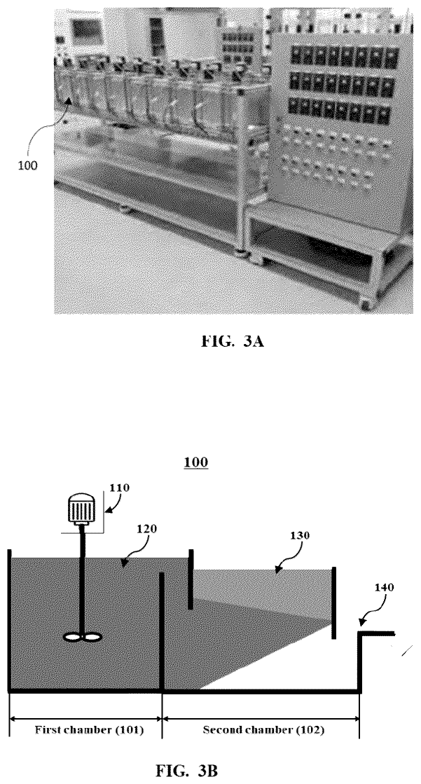

These extraction, cleaning, and stripping processes take place in the apparatus shown in FIGS. 3A and 3B, and in particular, each process takes place in step 100 of FIG. 3B, wherein the solvent extractant and the waste battery solution are mixed in step 100 as shown in FIG. 3B. Mixing the waste battery solution and solvent extractant via a settler 110 during mixing results in a mixture 120 of an organic phase 130 and an aqueous phase 140 as the solution is rotated at high speed within the first chamber 101.

However, the mixture 120 in the first chamber 101 passes into the second chamber 102, where the solution is again separated by density, causing the organic phase 130 to be separated into an upper layer and the aqueous phase 140 to be separated into a lower layer. At this time, the solvent extractant in the organic phase 130 and some of the metals in the waste battery solution are combined and extracted, and the unextracted metals are discharged along with the aqueous phase 140.

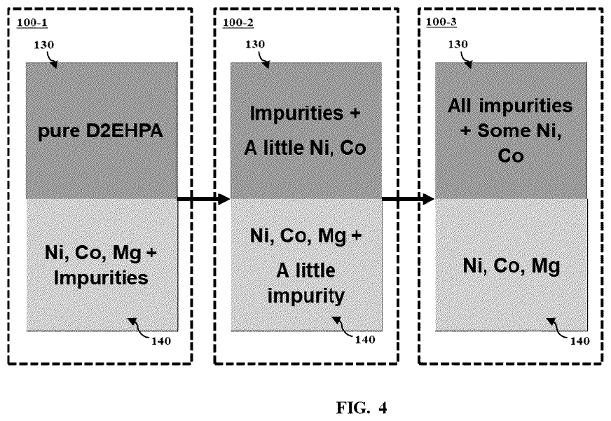

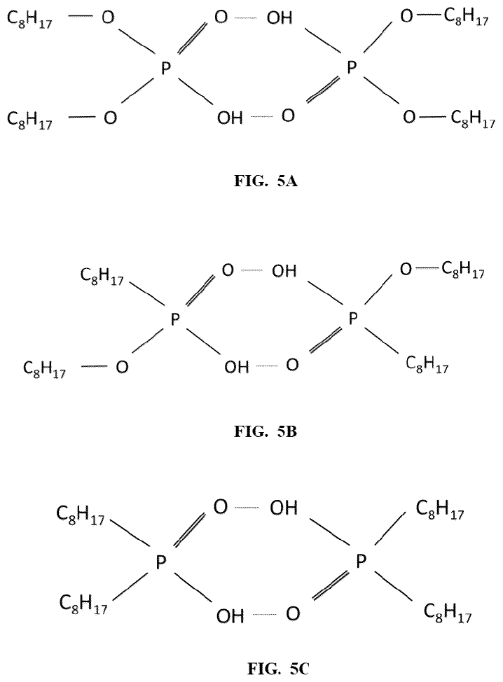

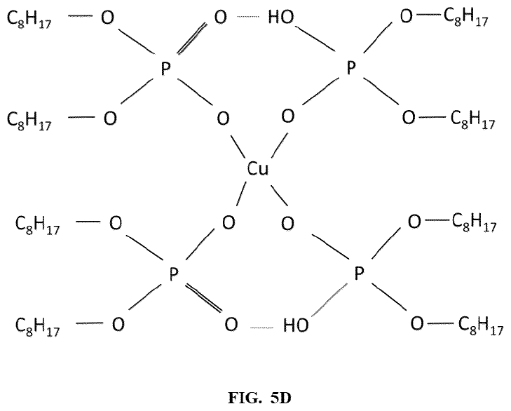

For example, referring to FIG. 4, first, the raw material comprising Ni, Co, and Mg is extracted by mixing the impurities Cu, Mn, Ca, Zn, and Fe with a solvent extractant in an impurity removal process. In the impurity removal process S100, the solvent extractant is, for example, D2EHPA, which is an organic substance having a structure as shown in FIG. 5A, and as shown in FIG. 5A, two D2EHPAs exist in a dimer state, for example, through hydrogen bonding. However, when reacting with the surrounding metal substance, it is separated from hydrogen and binds to the metal in place of hydrogen, forming a complex as shown in FIG. 5D to extract the metal. Therefore, the reaction of extracting metal ions by solvent extraction is composed of the complex and hydrogen ions that come out after the reaction with the solvent molecules forming a dimer, so the solvent extraction reaction is a pH-dependent reaction.

dimer A+dimer B+M²⁺→complex+2H₃O⁺ Chemical formula 1

In this case, within the extracted organic phase 130, some Ni, Co and Mg may be inadvertently contained and extracted. As the content of Ni and Co in the extracted organic phase 130 becomes higher, it becomes less economical, so it is necessary to add a step to reverse extract the Ni and Co contained in the organic phase again. Therefore, an apparatus and process for adding multiple steps is needed, as shown in FIG. 3A and FIG. 4. FIG. 4 is a schematic representation of what happens in several steps of FIG. 3A. Referring to FIG. 4, in the first step 100-1, there is a solvent extractant of D2EHPA in the organic phase, and the aqueous phase is a mixture of impurities with Ni, Co, and Mg. After several steps, such as the second step 100-2 and the third step 100-3, the proportion of Ni, Co, and Mg in the aqueous phase gradually increases and the proportion of Ni, Co, and Mg in the organic phase gradually decreases.

The present invention provides a method for increasing the efficiency of the impurity removal step S100 in order to reduce the number of steps. This requires a good separation between Ni, Co and impurity metals in the extraction process. In particular, Cu is the most difficult metal to separate among the impurities to be removed in the impurity removal step S100, and a good separation between Ni or Co, and impure metals including Cu can be advantageous for reducing the number of steps in the battery recycling process.

The inventors of the present invention have found that the separation of Ni and Co occurs significantly better than conventionally when a dialkylphosphoric acid-based solvent extractant and another solvent extractant exhibiting a synergistic effect are mixed and utilized in the impurity removal step S100 in order to increase the efficiency of the impurity removal step S100, and therefore, the following experiments and verifications have been performed on the impurity removal process using this solvent extractant.

### Preparation of Black Powder

To simulate a waste battery, a battery black powder solution with the following composition was prepared and extraction experiments were conducted. In this experiment, Li, Co, Ni, Mn, Cu, Al and Fe sulfate metals were dissolved in the proportions as shown in the table below to make a battery black powder simulation solution, and the mixed metal solution was mixed with a solvent to conduct an extraction experiment.

TABLE 1

| Elements | Li | Co | Ni | Mn | Cu | Al | Fe |
|---|---|---|---|---|---|---|---|
| % | 3.6 | 8.0 | 8.0 | 8.0 | 1.6 | 0.2 | 0.5 |
| mMol/L | 52 | 15 | 15 | 15 | 3 | | |

In this experiment, 0.01 M aqueous solutions of Li, Co, Ni, Mn, Cu, Al and Fe sulfates were prepared as the solution, and 0.04 M hydro-desulfurzed kerosine solution was prepared as the organic solution. Then, five solvent extractants were prepared by dissolving each of them in the organic solution (O/A ratio=1).
1) D2EHPA, a dialkylphosphoric acid-based solvent extractant,
2) CYANEX272, dialkylphosphinic acid-based solvent extractant,
3) PC88A, a dialkylphosphonic acid-based solvent extractant,
4) A blend of D2EHPA and cyanex272, a blend of dialkylphosphoric acid-based solvent extractants and dialkyl phosphinic acid-based solvent extractants,
5) D2EHPA and PC88A, a mixture of dialkylphosphoric acid-based solvent extractants and dialkyl phosphonic acid-based solvent extractants

The structures of dialkylphosphonic and dialkylphosphinic acid-based solvent extractants, e.g., PC88A and cyanex272, are shown in FIGS. 5B and 5C. The dialkylphosphonic acid-based solvent extractant PC88A (2-Ethylhexyl phosphonic acid mono-2-ethylhexylester) and the dialkylphosphinic acid-based solvent extractant cyanex272 (Bis-2,4,4-trimethylpentyl phosphinic acid) also exist in a dimeric state. PC88A is primarily used for the separation of Li and extraction of Co and Ni, while cyanex272 is primarily used to separate Li or Ni to extract Co.

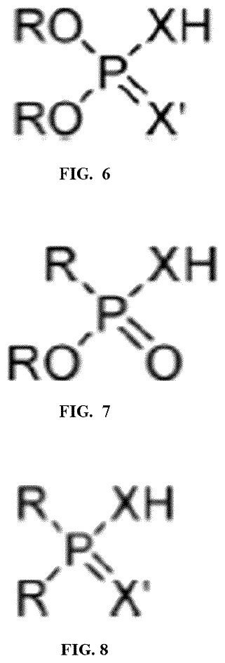

In the present disclosure, the dialkylphosphoric acid-based solvent extractant may have the structure of FIG. 6 and may be any of the substances shown in Table 2 below.

TABLE 2

| Substituents | | Commercial names |
|---|---|---|
| R | n-C₄H₉(C₂H₅)CHCH₂ | D2EHPA, DEHPA, |
| X = X′ | O | P204, Baysolvex |
| | | DEDP |
| R | n-C₄H₉(C₂H₅)CHCH₂ | Hoe F 3787 |
| X | O | |
| X′ | S | |
| R | n-C₄H₉(C₂H₅)CHCH₂ | DEHTPA |
| X = X′ | S | |

In one aspect, the dialkylphosphonic acid-based solvent extraction agent described herein may have the structure of FIG. 7 and may be a substance such as Table 3 below.

TABLE 3

| | | Commercial |
|---|---|---|
| Substituents | | names |
| R | n-C₄H₉(C₂H₅)CHCH₂ | PC 88A, P507, |
| X | O | Ionquest 801 |

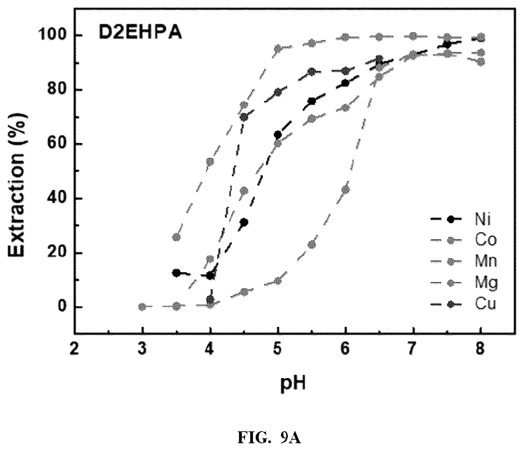

As used herein, the dialkylphosphinic acid-based solvent extractants may have the structure of FIG. 8 and may be substances such as those in Table 4 below.

TABLE 4

| | | Commercial |
|---|---|---|
| Substituents | | names |
| R | t-C₄H₉CH₂(CH₃)CHCH₂ | Cyanex 272 |
| X = X′ | O | |
| R | t-C₄H₉CH₂(CH₃)CHCH₂ | Cyanex 302 |
| X | O | |
| X′ | S | |
| R | t-C₄H₉CH₂(CH₃)CHCH₂ | Cyanex 301 |
| X = X′ | S | |

### E-pH Curve Experiments

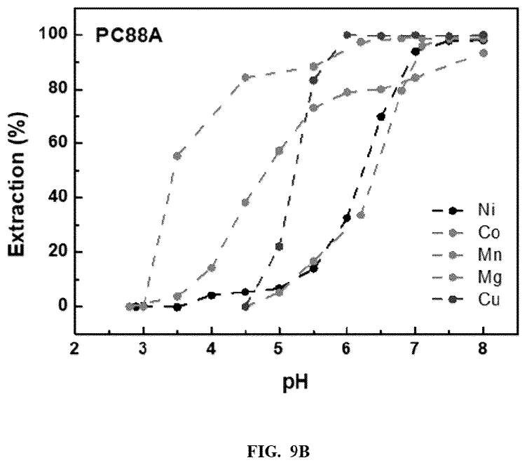

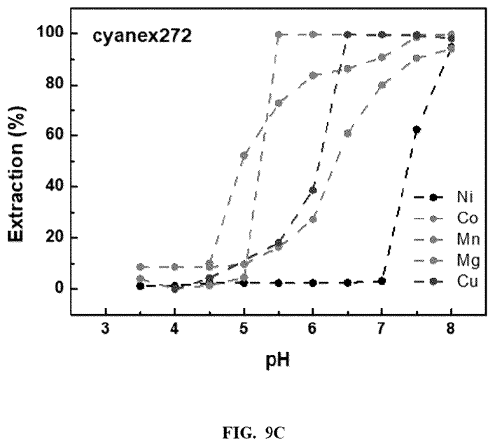

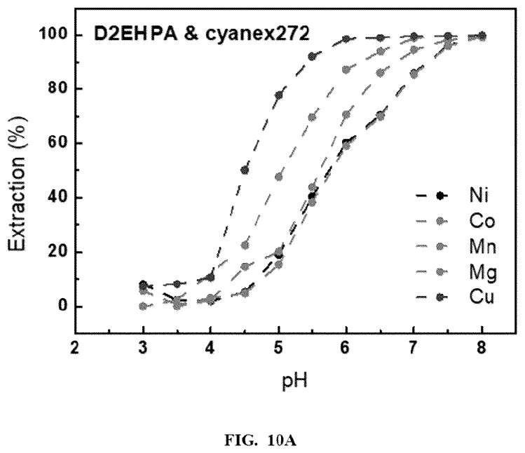

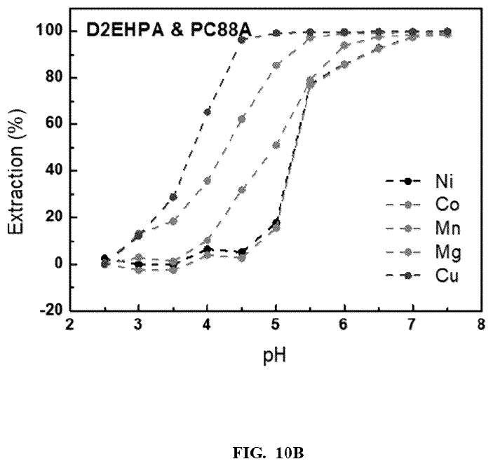

When metal ions are extracted by solvent extraction, the hydrogen in the solvent extractant is separated and ionized, resulting in an increase in pH. Therefore, the experimental E-pH curves of the reaction before mixing the solvent extractant are shown in FIGS. 9A to 9C, and the experimental E-pH curves of the reaction after mixing the solvent extractant showing synergistic effect are shown in FIGS. 10A and 10B.

As shown in FIGS. 9A to 9C and FIGS. 10A and 10B, the present invention demonstrates that Ni and Co can be separated from impurities at low pH concentrations. In particular, it can be observed that the separation of Co from Cu, which has been the most challenging to separate, is significantly enhanced when mixing solvent extractants that exhibit a synergistic effect. For instance, the present invention was able to improve the separation of Co from Cu between pH 2.0 and pH 3.0, which considerably reduced the number of steps in the impurity removal process.

Numerical verification of these experimental results is as follows. In Table 5 through Table 7 below, the Extraction Efficiency (%), Distribution Ratio, and Separation Factor were calculated as shown in Equation 1 through Equation 3, respectively.

$$E = \frac{{M}_{i} - {M}_{a}}{{M}_{i}} \qquad Equation 1$$

Where E is the extraction efficiency, Mi is the initial concentration of metal ions in the aqueous phase, and Ma is the final concentration of metal ions in the aqueous phase.

$$D = \frac{{M}_{i} - {M}_{a}}{{M}_{a}} \qquad Equation 2$$

Where D is the distribution ratio, Mi is the initial concentration of metal ions in the aqueous phase, and Ma is the final concentration of metal ions in the aqueous phase.

$${β}_{2}^{1} = \frac{{D}_{1}}{{D}_{2}} \qquad Equation 3$$

Where is the separation factor of substance 1 and substance 2, D1 is the distribution fraction of substance 1, and D2 is the distribution fraction of substance 2.

TABLE 5

| | | Extraction efficiency(%) | | Distribution ratio | | Separation |
|---|---|---|---|---|---|---|
| Extractant | pH | Cu | Co | Cu | Co | factor |
| D2EHPA | 2.5 | 91.56 | 28.23 | 10.8 | 0.39334 | 27.58007 |
| | 3 | 61.56 | 18.17 | 1.6 | 0.222046 | 7.212285 |
| cyanex272 | 3 | 5.564 | 6.606 | 0.06 | 0.070733 | 0.832971 |
| | 3.5 | 61.78 | 20.78 | 1.62 | 0.262307 | 6.162352 |
| PC88A | 2.5 | 6.844 | 2.552 | 0.07 | 0.026188 | 2.805378 |
| | 3 | 45.19 | 30.81 | 0.82 | 0.445296 | 1.851545 |

TABLE 6

| | | Extraction efficiency(%) | | Distribution ratio | | |
|---|---|---|---|---|---|---|
| Extractant | pH | Cu | Co | Cu | Co | Separation factor |
| D2EHPA & | 2.5 | 26.2604 | 0.99502 | 0.35612 | 0.01005 | 35.4343 |
| Cyanex272 | 2.6 | 28.55 | 1.553 | 0.39958 | 0.015775 | 25.32998 |
| (1:1) | 2.7 | 38.21 | 3.235 | 0.618385 | 0.033432 | 18.49707 |
| | 2.8 | 47.33 | 5.274 | 0.898614 | 0.055676 | 16.13995 |
| | 2.9 | 56.26 | 7.966 | 1.286237 | 0.086555 | 14.86035 |
| | 3 | 64.46 | 11.2 | 1.813731 | 0.126126 | 14.3803 |
| D2EHPA & | 2.5 | 38.563 | 1.36507 | 0.62768 | 0.01384 | 45.3541 |
| Cyanex272 | 2.6 | 30.78 | 1.67 | 0.444669 | 0.016984 | 26.18223 |
| (2:1) | 2.7 | 41.11 | 3.55 | 0.698081 | 0.036807 | 18.96618 |
| | 2.8 | 51.21 | 5.92 | 1.0496 | 0.062925 | 16.68013 |
| | 2.9 | 60.4 | 8.92 | 1.525253 | 0.097936 | 15.57399 |
| | 3 | 68.66 | 12.77 | 2.19081 | 0.146395 | 14.96511 |
| D2EHPA & | 2.5 | 39.06 | 2.83 | 0.64096 | 0.02912 | 22.0077 |
| Cyanex272 | 2.6 | 46.79 | 5.19 | 0.879346 | 0.054741 | 16.06374 |
| (3:1) | 2.7 | 55.17 | 8.16 | 1.230649 | 0.08885 | 13.85084 |
| | 2.8 | 63.07 | 12.1 | 1.707826 | 0.137656 | 12.40644 |
| | 2.9 | 70.49 | 16.63 | 2.388682 | 0.199472 | 11.97501 |
| | 3 | 77.16 | 21.69 | 3.378284 | 0.276976 | 12.19702 |

TABLE 7

| | | Extraction efficiency(%) | | Distribution ratio | | |
|---|---|---|---|---|---|---|
| Extractant | pH | Cu | Co | Cu | Co | Separation factor |
| D2EHPA & | 2.5 | 58.1636 | 4.40394 | 1.39026 | 0.04607 | 30.1784 |
| PC88A | 2.6 | 50.76 | 2.418 | 1.030869 | 0.024779 | 41.60227 |
| (1:1) | 2.7 | 57.59 | 4.485 | 1.357934 | 0.046956 | 28.91931 |
| | 2.8 | 66.92 | 8.054 | 2.022975 | 0.087595 | 23.09466 |
| | 2.9 | 76.25 | 13 | 3.210526 | 0.149425 | 21.48583 |
| | 3 | 83.87 | 21.12 | 5.199628 | 0.267748 | 19.41982 |
| D2EHPA & | 2.5 | 46.25 | 1.37 | 0.860465 | 0.01389 | 61.94721 |
| PC88A | 2.6 | 55.3 | 2.51 | 1.237136 | 0.025746 | 48.05117 |
| (2:1) | 2.7 | 63.99 | 4.28 | 1.777006 | 0.044714 | 39.74183 |
| | 2.8 | 71.23 | 6.8 | 2.475843 | 0.072961 | 33.93361 |
| | 2.9 | 77.62 | 10.4 | 3.468275 | 0.116071 | 29.88053 |
| | 3 | 82.84 | 15.16 | 4.827506 | 0.178689 | 27.0162 |
| D2EHPA & | 2.5 | 42.8105 | 2.731249 | 0.748573 | 0.028079 | 26.65913 |
| PC88A | 2.6 | 44.49 | 6.66 | 0.801477 | 0.071352 | 11.23272 |
| (3:1) | 2.7 | 47.53 | 10.66 | 0.905851 | 0.119319 | 7.591813 |
| | 2.8 | 50.31 | 15.18 | 1.012477 | 0.178967 | 5.657334 |
| | 2.9 | 53.26 | 20.1 | 1.139495 | 0.251564 | 4.529635 |
| | 3 | 56.85 | 25.66 | 1.317497 | 0.345171 | 3.816942 |

Referring to Table 5 to Table 7, it can be seen that, compared to utilizing D2EHPA alone as utilized in the conventional process, the separation coefficient of Cu and Co is significantly improved when D2EHPA, a dialkylphosphoric acid-based solvent extractant, is mixed with a dialkylphosphonic acid-based solvent extractant and a dialkyl phosphinic acid-based solvent extractant, such as PC88A and cyanex272, at a target pH, e.g., pH 2.0 to 3.0, and more preferably at pH 2.5 to 3.0, a significant improvement in the separation coefficient of Cu and Co can be seen. In particular, it can be seen that the separation coefficient is increased when D2EHPA is mixed with a synergistic solvent extractant, preferably in a ratio of 1:1 to 3:1 or less, most preferably 2:1. In particular, a 63.7% increase in the separation factor was observed when D2EHPA was mixed 2:1 with cyanex272, and a 125% increase in the separation factor was observed when D2EHPA was mixed 2:1 with PC88A.

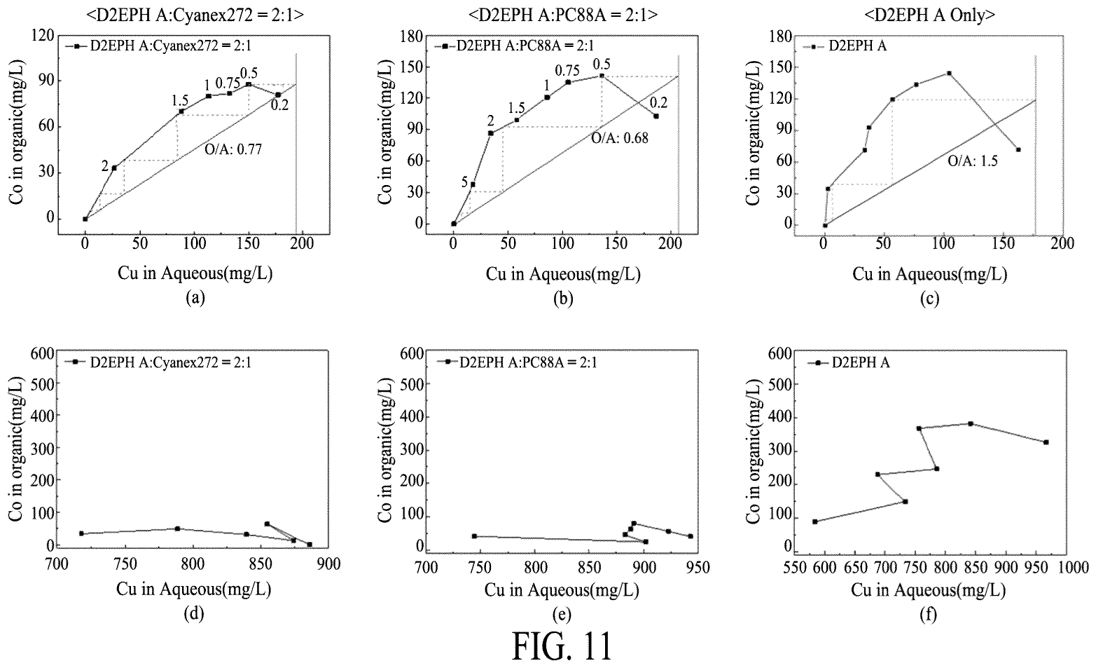

Also, referring to FIG. 11, it can be seen that when only a dialkylphosphoric acid-based solvent extractant is used, Co continues to remain in the organic phase, but when a mixed solvent extractant according to the present invention is used, only a very small amount of Co remains in the organic phase, resulting in much better separation. Specifically, in (c) and (f) of FIG. 11, graphs of Cu and Co in the organic and aqueous phases, respectively, when D2EHPA alone is used, there is still Co in the organic phase after repeated extractions. However, referring to (a), (b), (d), and (e) of FIG. 11 using the mixed solvent extractant according to the present invention, it can be seen that much of the Co is removed from the organic phase.

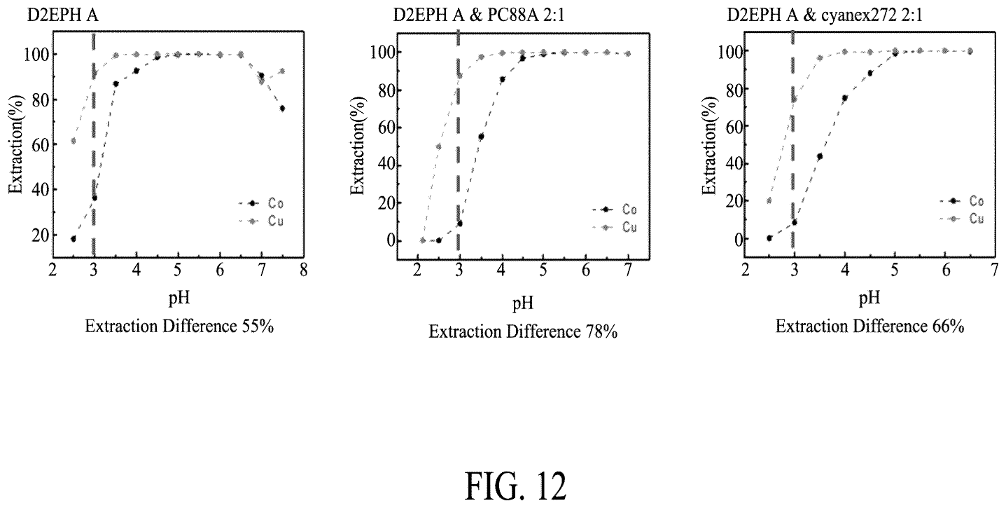

Referring to FIG. 12, it can be seen that the difference in extraction % has increased considerably when using the mixed solvent extractant according to the present invention, and it can also be seen that the separation is proceeding well because the amount of Co in the extraction remains very small.

### DFT Calculations

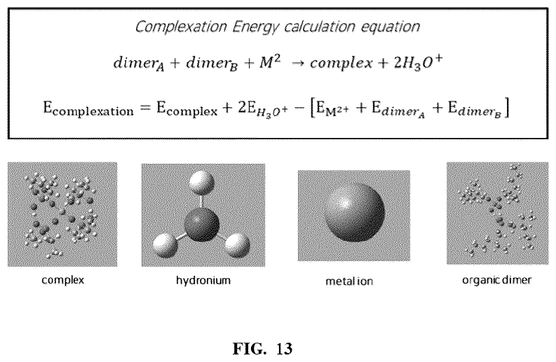

To verify the effectiveness of the present invention, the molecules and metals involved in the reaction were modeled using Nurion, Gaussian, and avogadro programs, as shown in FIG. 13, and the thermodynamic energies of each were calculated by DFT calculations. For the reaction equation shown in FIG. 13, the thermodynamic energies of each of the solvent extractants, when mixed, were calculated. In this case, Basis indicates the characteristic value of each substance underlying the calculation, and E (RB3LYP) indicates the result of subtracting the enthalpy value of the product from the enthalpy value of the reactant. In other words, the smaller the E (RB3LYP), the more stable the reaction.

The basis and E (RB3LYP) of each molecule and metal in the complex of D2EHPA and cyanex272 in the reaction equation are shown in Table 8.

TABLE 8

| | Hydronium | D2EHPA | Cyanex272 | | | | | |
|---|---|---|---|---|---|---|---|---|
| | ion | dimer | dimer | Ni | Co | Mn | Mg | Cu |
| Basis | 6-31 g+ | 6-31 g+ | 6-31 g+ | Lanl2dz | Lanl2dz | Lanl2dz | Lanl2dz | Lanl2dz |
| E(RB3LYP) | −76.7042 | −932.81 | −631.97 | −168.161 | −143.991 | −102.844 | −0.81992 | −195.065 |

The complex and complexation energy of D2EHPA mixed with cyanex272 are given below.

TABLE 9

| | Ni | Co | Mn | Mg | Cu |
|---|---|---|---|---|---|
| Basis(pseudo | Lanl2dz & | Lanl2dz & | Lanl2dz & | Lanl2dz & | Lanl2dz & |
| potential) | 6-31 g+ | 6-31 g+ | 6-31 g+ | 6-31 g+ | 6-31 g+ |
| Complex | −3440.86 | −3414.58 | −3458.94 | −2967.58 | −3548.47 |
| E(B3LYP) | | | | | |
| Complex- | −2197.65 | −2147.2 | −2150.42 | −1557.03 | −2332.16 |
| ation | | | | | |
| E(B3LYP) | | | | | |

Meanwhile, the basis and energy (E(RB3LYP)) of each molecule and metal in the formation of the complex of D2EHPA and PC88A in the reaction equation are as follows

TABLE 10

| | Hydronium | D2EHPA | PC88A | | | | | |
|---|---|---|---|---|---|---|---|---|
| | ion | dimer | dimer | Ni | Co | Mn | Mg | Cu |
| Basis | 6-31 g+ | 6-31 g+ | 6-31 g+ | Lanl2dz | Lanl2dz | Lanl2dz | Lanl2dz | Lanl2dz |
| E(RB3LYP) | −76.7042 | −932.81 | −631.97 | −168.161 | −143.991 | −102.844 | −0.81992 | −195.065 |

Furthermore, the complex and complexation energies for the mixture of D2EHPA and PC88A are as follows.

TABLE 11

| | Ni | Co | Mn | Mg | Cu |
|---|---|---|---|---|---|
| Basis(pseudo | Lanl2dz & | Lanl2dz & | Lanl2dz & | Lanl2dz & | Lanl2dz & |
| potential) | 6-31 g+ | 6-31 g+ | 6-31 g+ | 6-31 g+ | 6-31 g+ |
| Complex | −3613.08 | −3581.33 | −3518.7 | −3555.37 | −3666.95 |
| E(B3LYP) | | | | | |
| Complex- | −1097.61 | −1090.02 | −1068.54 | −1207.23 | −1124.57 |
| ation | | | | | |
| E(B3LYP) | | | | | |

In other words, the complexation energy (complexation E) of Cu is the largest measured, indicating that the stabilization energy is large, and the energy decreases significantly upon mixing the solvent extractant. Therefore, it can be seen that the mixing of solvent extractants has a synergistic effect that significantly lowers the energy required for the reaction in a given complex formation reaction. Thus, it can be seen from the thermodynamic energy calculation that the separation of Cu and Co is most easily accomplished when the solvent extractants having a synergistic effect such as the present invention are mixed, and that the number of steps in the impurity removal process can be greatly reduced.

Thus, according to one embodiment of the present invention, a wet extraction method for Cu separation and Co recovery that significantly reduces the number of impurity removal steps, thereby increasing the efficiency of the extraction process, may be provided.

In particular, according to one embodiment of the present invention, a wet extraction method is provided that provides good separation between metals in the extraction process and that uses synergistic effects to reduce the number of steps in the impurity separation process. More specifically, according to one embodiment of the present invention, the separation of Co and Cu, which were the most difficult to separate in the first impurity removal process, is significantly facilitated, and in particular, the cost of the process can be significantly reduced by synergistically removing Cu, which was previously difficult to separate.

The present invention discloses a combination of mixed solvents that can effectively separate Mn and Cu, from Ni, Co, Li, Mn, and Cu. Accordingly, the present invention is necessary for removing impurities in recycling waste batteries, thereby reducing the number of steps in the extraction and separation steps of the impurity removal process that separates the valuable metals Ni, Co, and Li from impurities. Reducing the number of steps reduces the cost of the process and the number of organic solvents used in the process, resulting in cost savings.

Since the solvent extraction process is operated in a large-scale plant unit, it is not easy to control pH, temperature, solution volume, etc. Therefore, there has not been much research on mixed solvents that are difficult to control the amount and pH, and research on waste battery recycling has emerged recently, so there has been no research on finding suitable solvent extraction conditions under waste battery conditions. The present invention derives solvent combinations and calculation of the number of steps for a more effective extraction process without plant experiments through E-pH relationship graphs and DFT calculations at the lab scale, and the application of the invention is expected to reduce both process design and process operation costs.

Embodiments of the present invention have been described in more detail with reference to the accompanying drawings, but the invention is not necessarily limited to these embodiments and may be practiced in various modifications without departing from the technical ideas of the invention. Accordingly, the embodiments disclosed herein are intended to illustrate and not to limit the technical ideas of the present invention, and the scope of the technical ideas of the present invention is not limited by these embodiments. Therefore, the embodiments described above are exemplary in all respects and should be understood as non-limiting. The scope of protection of the present invention shall be construed in accordance with the following claims, and all technical ideas within the scope thereof shall be construed as falling within the scope of the present invention.

Explanation of drawing symbols

| | |
|---|---|
| S100: Impurity Removal Steps | S120: Extraction process |
| S130: Cleaning process | S140: Removal process |
| S200: Co extraction step | S300: Ni extraction step |
| 100: Step | 130: Organic phase |
| 140: Aqueous phase | |

What is claimed is:

1. A method for recovering valuable metals from waste batteries, the method comprising:
an impurity removal process that removes impurities, including Cu, from the raw materials of the waste batteries and discharges an aqueous phase containing Ni and Co; and
a Co extraction process that extracts Co from the aqueous phase containing Ni and Co to discharge an aqueous phase containing Ni;
wherein the impurity removal process involves mixing a dialkylphosphoric acid-based solvent extractant with another solvent extractant exhibiting a synergistic effect to increase a separation factor between Co and Cu.

2. The method of claim 1, further comprising a Ni extraction process for extracting Ni from the aqueous phase containing Ni.

3. The method of claim 1, wherein the synergistic effect results from a reaction in which enthalpy of reactants is lower than enthalpy of products when mixing the another solvent extractant, leading to a formation of a complex by combining impurities and dimers of the dialkylphosphoric acid-based solvent extractant.

4. The method of claim 1, wherein the another solvent extractant exhibiting the synergistic effect includes dialkylphosphonic acid-based solvent extractants or dialkylphosphinic acid-based solvent extractants.

5. The method of claim 4, wherein the dialkylphosphonic acid-based solvent extractant includes any one of PC88A, P507, and Ionquest 801.

6. The method of claim 4, wherein the dialkylphosphinic acid-based solvent extractant comprising any one of Cyanex 272, Cyanex 302, Cyanex 301.

7. The method of claim 1, wherein the dialkylphosphoric acid-based solvent extractant and the another solvent extractant exhibiting the synergistic effect are mixed in a ratio of 1:1 to 3:1.

8. The method of claim 7, wherein the dialkylphosphoric acid-based solvent extractant and the another solvent extractant exhibiting the synergistic effect are mixed in a ratio of 2:1.

9. The method of claim 1, wherein in the impurity removal process, the reaction in which the dimer of the dialkylphosphoric acid-based solvent extractant and the impurity are combined to form a complex occurs at pH 2.0 to pH 3.0.

10. The method of claim 1, wherein the aqueous phase includes solution of sulfuric acid or hydrochloric acid, and the organic phase is dissolved by mixing hydrodesulfurized kerosene solution, an organic solution with the dialkylphosphoric acid-based solvent extractant and the dialkylphosphonic acid-based solvent extractant or the dialkylphosphinic acid-based solvent extractant and,
wherein the aqueous phase and the organic phase are mixed in a first chamber under high-speed rotation through a settler, and then transferred to a second chamber where they are separated by density.

11. The method of claim 1, wherein the dialkylphosphoric acid-based solvent extractant comprising any one of D2EPHA, DEHPA, P204, Baysolvex, DEDP, Hoe F 3787, and DEHTPA.
